(19) United States
(12) Patent Application Publication
(10) Pub. No.: US 2022/0225688 A1
(43) Pub. Date: Jul. 21, 2022

(54) ANTI-CHAFING THIGH GUARD

(71) Applicant: Brittany Lammon, Fort Lauderdale, FL (US)

(72) Inventor: Brittany Lammon, Fort Lauderdale, FL (US)

(21) Appl. No.: 17/552,952

(22) Filed: Dec. 16, 2021

Related U.S. Application Data
(60) Provisional application No. 63/138,413, filed on Jan. 16, 2021.

(51) Int. Cl. A41B 9/12; C09J 9/00; C09J 7/21

(52) U.S. Cl. CPC A41B 9/12; C09J 9/00; C09J 7/21; C09J 2301/204; A41B 2500/52; A41B 2400/22; C09J 2203/358; A41B 2500/20

(57) ABSTRACT

Provided is an anti-chafing thigh guard. The anti-chafing thigh guard includes at least one adhesive patch. Each adhesive patch in the at least one adhesive patch is constructed of a linear sheet of material having a top surface and a bottom surface. The top surface defines a non-abrasive texture. The linear sheet of material comprises an elastic, flexible, water-resistant, and hypoallergenic material. The sides of the at least one adhesive patch are defined by a geometrical shape of a first linear side connecting two rounded ends which are thereby connected by a curved second side, wherein the curvature of the second side allows the at least one patch to adhere to variable polar curvature of a user's skin. The geometrical shape of each patch provides a surface area configured to provide full coverage of an area of a user's skin subject to increased friction.

### CROSS-REFERENCE TO RELATED APPLICATION

This application claims the benefit under 35 USC 119(e) of provisional patent application Ser. No. 63/138,413, filed Jan. 16, 2021, all of which is incorporated by reference in its entirety.

### FIELD OF INVENTION

The invention relates generally to a thigh guard that prevents blister and chafing.

### BACKGROUND

A number of solutions may be found for thigh chafing. Some of these solutions attempt to cover a sensitive area of a user's skin with a gel or powder to avoid chafing, but these solutions fail to meet the needs of the industry because they do not last as long as the consumer needs. Further, these gels and powders are very messy in their applications. Other solutions attempt to cover the thigh with a large piece of lace encompassing the whole top of the thigh but these solutions are similarly unable to meet the needs of the industry because these solutions can be seen and may also be uncomfortable.

Therefore, there currently exists a need in the industry for a device and associated method that is that prevents blisters and thigh chafing in a discreet manor and is sweat proof, stays on all day, and is a no mess application.

### SUMMARY OF THE INVENTION

Provided is an anti-chafing thigh guard. The anti-chafing thigh guard includes at least one adhesive patch. Each adhesive patch in the at least one adhesive patch is constructed of a linear sheet of material having a top surface and a bottom surface. The top surface defines a non-abrasive texture. The linear sheet of material comprises an elastic, flexible, water-resistant, and hypoallergenic material. The sides of the at least one adhesive patch are defined by a geometrical shape of a first linear side connecting two rounded ends which are thereby connected by a curved second side, wherein the curvature of the second side allows the at least one patch to adhere to variable polar curvature of a user's skin. The geometrical shape of each patch provides a surface area configured to provide full coverage of an area of a user's skin subject to increased friction.

It is an object of the invention to provide a thigh guard that can eliminate thigh chafing and prevented thigh blisters.

It is a further object of the invention to have a device that is be sweat proof, stays on all day, and remains discreet.

It is yet further an object to have a device that is easily applied with no mess.

The drawings and specific descriptions of the drawings, as well as any specific or alternative embodiments discussed, are intended to be read in conjunction with the entirety of this disclosure. The invention may be embodied in many different forms and should not be construed as being limited to the embodiments set forth herein; rather, these embodiments are provided by way of illustration only and so that this disclosure will be thorough, complete and fully convey understanding to those skilled in the art. The above and yet other objects and advantages of the present invention will become apparent from the hereinafter set forth Brief Description of the Drawings, Detailed Description of the Invention, and Claims appended herewith.

### BRIEF DESCRIPTION OF THE DRAWINGS

FIG. 1 illustrates a front isometric view of a thigh guard.

FIG. 2 illustrates a top view of the thigh guard.

FIG. 3 illustrates a bottom view of the thigh guard.

FIG. 4 illustrates a bottom view of the thigh guard with a cover.

FIG. 5 illustrates a right-side view of the though guard.

FIG. 6 illustrates a left side view of the thigh guard.

FIG. 7 illustrates a front view of the thigh guard.

FIG. 8 illustrates a rear view of the thigh guard.

FIG. 9 illustrates an enlarged isolated rear view of the thigh guard

FIG. 10 illustrates an enlarged isolated rear view of the thigh guard showing the intermittent adhesive material.

FIG. 11 is a conceptual view of a step in the application of the thigh guard.

FIG. 12A is a conceptual view of a step in the application of the thigh guard.

FIG. 12B is a conceptual view of a step in the application of the thigh guard.

FIG. 13A is a conceptual view of a step in the application of the thigh guard.

FIG. 13B is a conceptual view of a step in the application of the thigh guard.

FIG. 14 is a conceptual view of the thigh guard on a user.

FIG. 15 is a view of the thigh guard on the skin of a user.

FIG. 16 is a view of different areas of applications of a thigh guard on a user.

### DETAILED DESCRIPTION OF THE INVENTION

The thigh guard provides a solution to an easy to use, and in some embodiments reusable, solution to anti-chafing methods. When walking around for extended periods of time, a person may develop chafing or other irritation from the friction of repetitive rubbing of skin on skin contact associated with walking and other similar activities. This risk increases as a user's body mass increases. The current invention disclosed herein reduces chafing and other irritation by providing a barrier on a user's skin.

The thigh guard, which is made up of material that is placed on a user's thigh, has an adhesive agent on the portion that contact's the users skin to affix the thigh guard to the user's sensitive areas. During application, the thigh guard will have a backing that is taken off to expose the adhesive agent and the side that is exposed will be placed on the part of the thigh that can come in contact with the other thigh. An exact replica of one thigh guard will be placed on the opposite thigh directly across from the other guard. That is, one thigh guard is placed on one thigh and the other on the opposite thigh directly across from each other.

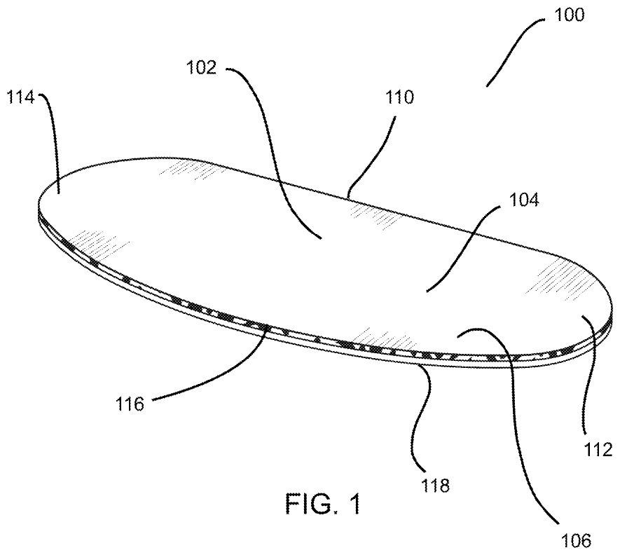

In a general sense, the thigh guard is unique when compared with other known solutions because in various embodiments, it may provide a material such a mole skin, a breathable material, a waterproof material, and/or a plastic material to prevent the rubbing and irritation. Further, the thigh guard may be constructed in various embodiments to encompass a range of sizes and shapes, including a circle, oval, rectangle, square, heart, and or a triangle. The exact shape and size of an embodiment may be calibrated based on use and an ideal fit for a user, where some shapes may perform better. For example, in the exemplary embodiment of the invention as shown in FIGS. 1-16, the patch is shown in an asymmetrical shape which better fits the user's thigh region and adapts to the curvature of the skin through the implementation of the unique shape.

In some embodiments, the thigh guard could be made out of a different materials, including, but not limited to cloth, fabric, textile, and or a transparent film, each with its own characteristics and applications. The thigh guard could be placed on the thigh with any material besides or including an adhesive agent. The thigh guard works for all-day applications, and is not messy to put on. Further, the thigh guard eliminates thigh chafing in locations where the product is placed. The thigh guard is sweatproof, discreet, and lasts all day. This may particularly be valuable when activities include exercise or sporting competitions.

The device may be made up of a patch with one side that is sticky so it will attach to the inner part of the thigh. The opposite side of the same patch will be very smooth. One patch will be placed on one thigh and another patch will be placed on the opposite thigh and they will be worn at the same time. In some embodiments, the patch will be in a curved shape to allow for stretchability on skin, and may come in different sizes for different size thighs. When the patch comes out of the packaging it will have a backing on the adhesive side that will need to be pulled off to expose the adhesive side and then will be placed on the skin. The patch can be made out of various materials such as tegaderm, a transparent medical dressing, mole skin, plastic, woven fabric, coated paper, latex, pvc or similar materials. In some embodiments, the patch may be made out of a waterproof or water-resistant material, or incorporate waterproof and water-resistant properties through application of a waterproofing agent.

An exemplary embodiment is shown and may be seen in FIGS. 1-16. In the exemplary embodiment of the invention an anti-chafing thigh guard 100 is shown. The anti-chafing thigh guard 100 includes at least one adhesive patch 102. Each adhesive patch 102 is constructed of a linear sheet of material 104 having a top surface 106 and a bottom surface 108. The top surface 106 defines a non-abrasive texture. The disclosed embodiment is constructed from a woven material that is non-abrasive so that the patch 102 does not make a noticeable sound when a user is walking. The linear sheet of material 104 comprises an elastic, flexible, water-resistant, and hypoallergenic material. The sides of the at least one adhesive patch are defined by a geometrical shape of a first linear side 110 connecting two rounded ends 112/114 which are thereby connected by a curved second side 116, wherein the curvature of the second side 116 allows the patch 102 to adhere to variable polar curvature of a user's skin 200. The geometrical shape of each patch 102 provides a surface area configured to provide full coverage of an area of a user's skin subject to increased friction. As noted above, the unique geometry shown in FIGS. 1-16 employs a linear side 110, which allows fuller coverage closer to a crease in a user's body, such as an armpit or pelvic joint, as shown in FIG. 16. The curved side 116 allows fuller coverage on areas that do not have a crease or joint such that the curved end 116 provides fuller coverage for unencumbered areas of the user's body, i.e., areas of the body that are not limited by creases or joints with other body parts.

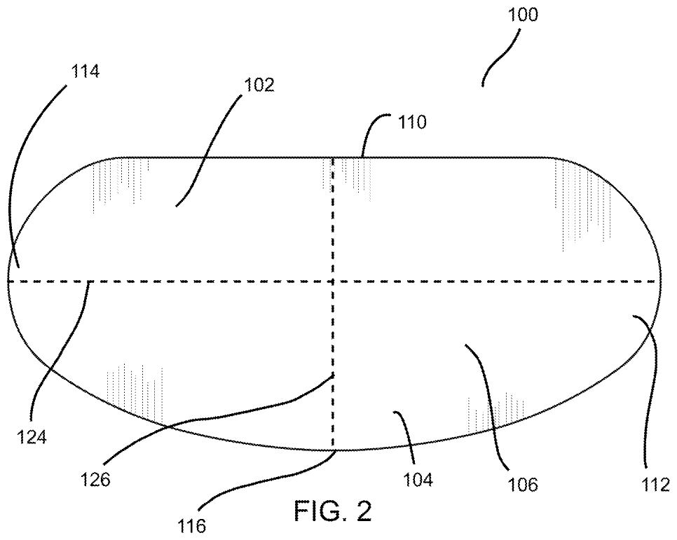

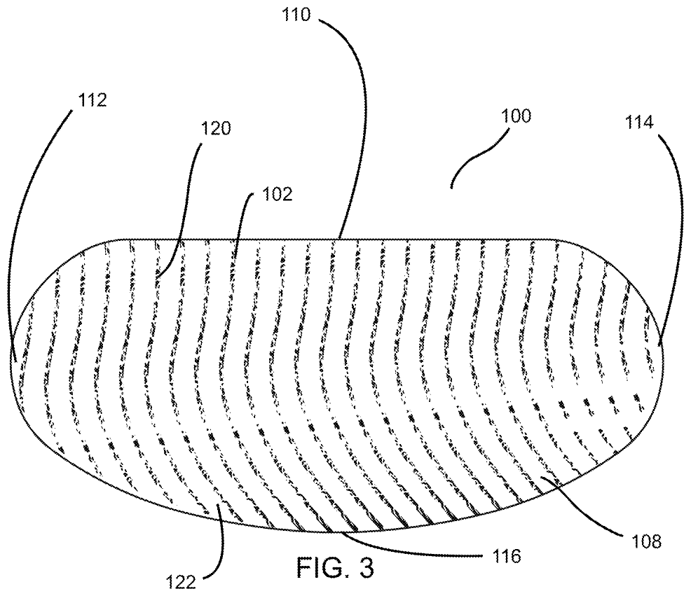

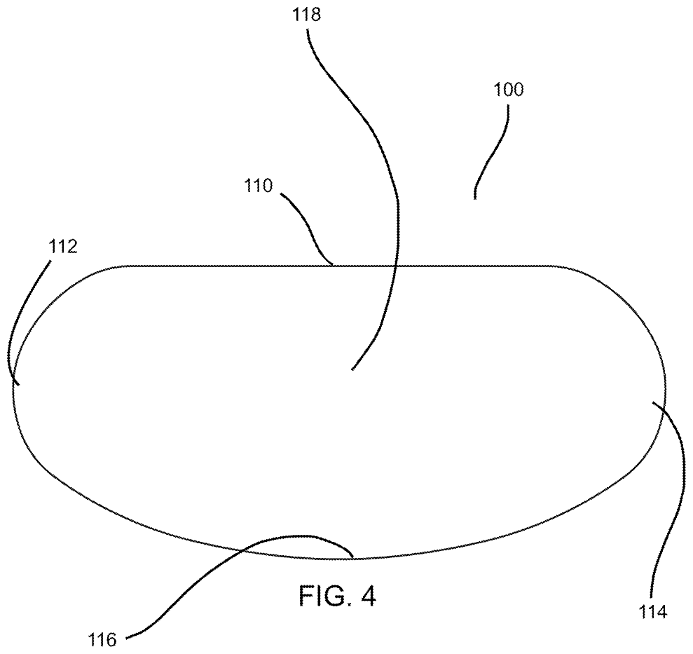

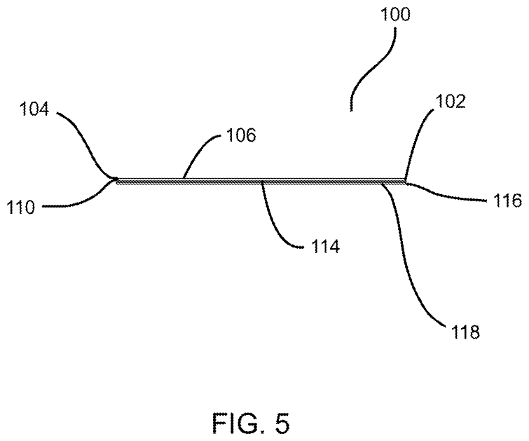

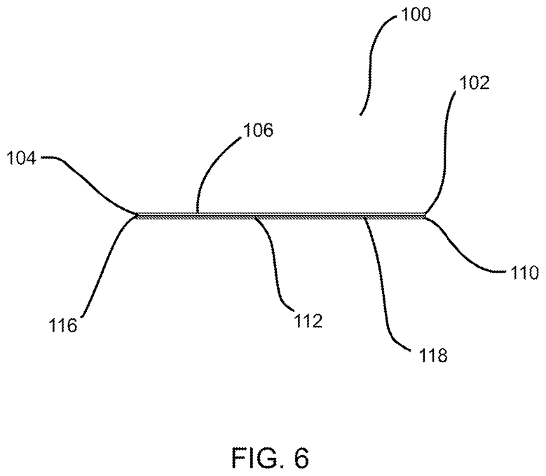

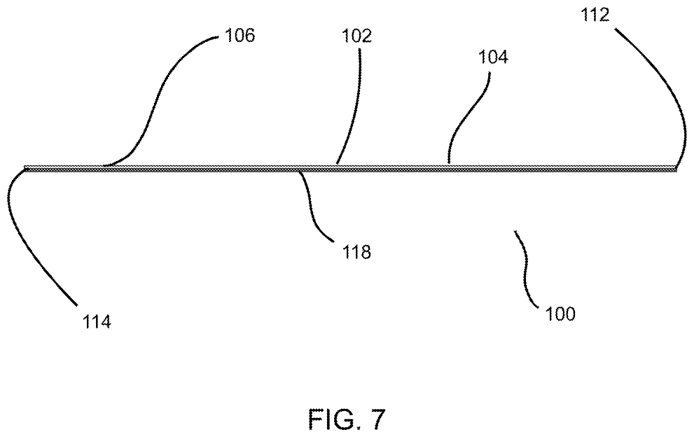

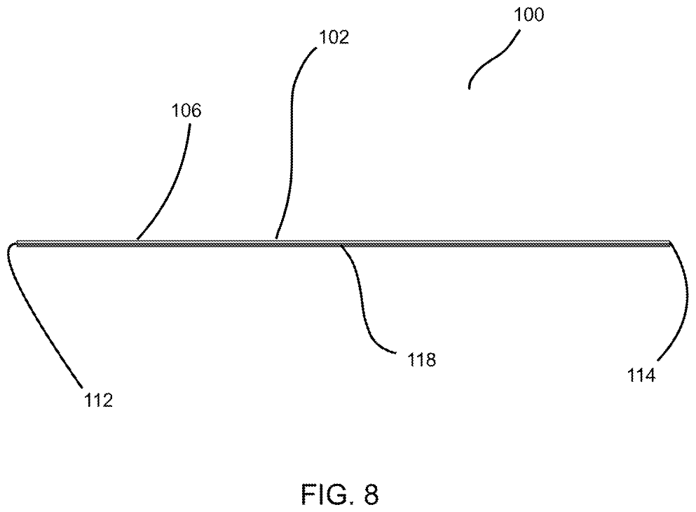

The general geometric shape and properties of the thigh guard 100 may be particularly seen in FIGS. 1-8. FIG. 1 illustrates a front isometric view of a thigh guard 100. FIG. 2 illustrates a top view of the thigh guard 100. FIG. 3 illustrates a bottom view of the thigh guard 100. FIG. 4 illustrates a bottom view of the thigh guard with a cover 118. FIG. 5 illustrates a right-side view of the thigh guard 100. FIG. 6 illustrates a left side view of the thigh guard 100. FIG. 7 illustrates a front view of the thigh guard 100. FIG. 8 illustrates a rear view of the thigh guard 100.

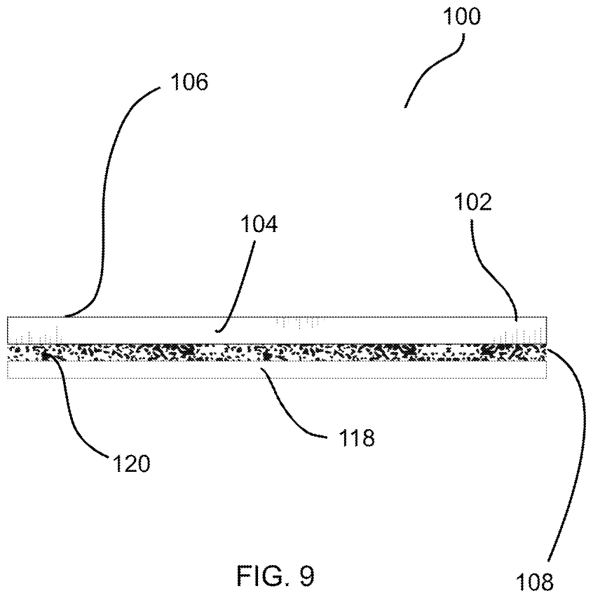

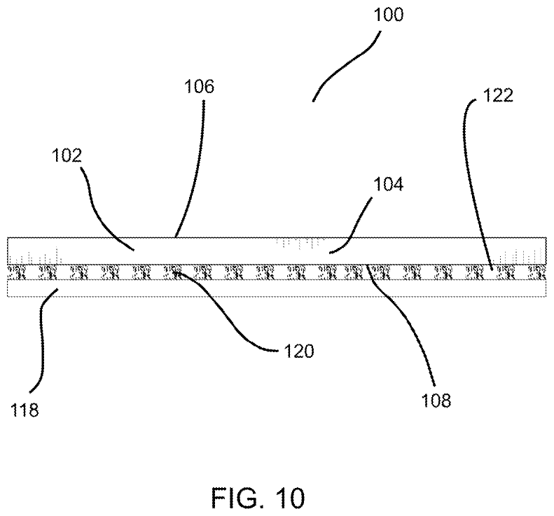

FIGS. 9 and 10 provide an enlarged view of the thigh guard 100. FIG. 9 illustrates an enlarged isolated rear view of the thigh guard, while FIG. 10 illustrates an enlarged isolated rear view of the thigh guard 100 showing the intermittent adhesive material 120.

In some embodiments of the anti-chafing thigh guard 100, the bottom surface 108 of the at least one adhesive patch 102 comprises a plurality of intermittent adhesive material strips 120 affixed thereon. The plurality of intermittent adhesive material strips 120 allow sweat from a user to perspire from the user's skin on non-adhesive areas 122, allowing the adhesive material 120 to affix to a user's skin without significant accumulation of sweat in locations of the plurality of intermittent adhesive material strips 120. These strips 120 run from the top to the bottom on the underside 108 of the thigh guard 100, allowing a snug fit without the risk of loose-hanging portions, which could cause the patch 102 to come off. The strips also allow additional elasticity in the areas where no adhesive is present 122, as the adhesive may be less elastic then the material of the thigh guard 100, shown particularly in FIG. 10. The plurality of the intermittent adhesive material strips 120 may be arranged in a wave pattern, as shown in FIG. 3 in a geometrical configuration that allows for flexibility and stretchability to accommodate a plurality of curvatures of a user's skin 200, whereby stretching of the linear sheet of material 104 does not affect the adhesive ability of the at least one adhesive patch 102.

While patches 102 may be worn individually, a pair of identical adhesive patches 102 is typically included to allow the patches to rub against themselves instead of the user's thigh(s). This can be seen primarily in FIG. 16, wherein the figure also shows other areas the patches may be applied to.

Textures and materials of the thigh guard 100 may differ with certain embodiments. In some embodiments of the anti-chafing thigh guard 100, the linear sheet of material 104 may include a smooth surface texture to prevent pulling as a result of friction against the at least one adhesive patch 102. In some embodiments of the anti-chafing thigh guard 100, the linear sheet of material 104 provides a soft consistency to allow increased malleability when affixing to a user's skin. In some embodiments of the anti-chafing thigh guard 100, the linear sheet of material 104 comprises a breathable woven texture. In some embodiments of the anti-chafing thigh guard 100, the linear sheet of material 104 may be a natural fabric. In some embodiments, the linear sheet of material 104 may be a synthetic material. In some embodiments, the synthetic material may be a plastic material. In the exemplary embodiment, shown in FIGS. 1-16, the material 104 is a 100% cotton material with a 100% poly-acrylic adhesive on the back 108. There is no latex in the embodiment, making it hypoallergenic.

Unlike other skin adhesives, the thigh guard 100 must be large enough to cover a user's sensitive skin. FIG. 2 shows the width and length locations of the thigh guard 100. In some embodiments linear sheet of material 104 has a width measurement 124 in a range from 4-inches to 12-inches. The larger the width, the more the thigh guard can cover a user's skin, and the larger body mass the thigh guard can accommodate. The linear sheet of material 104 has a height measurement 126 in a range from 2-inches to 6-inches.

A protective cover/backing 118 is included for protecting the adhesive material 120 on the bottom surface 108 of the at least one adhesive patch 102 to prevent the adhesive patch 102 from affixing itself to an object when not in use. Without the cover 118, particulates may attach themselves to the adhesive 120, or the adhesive 120 may get entangled amongst itself. Prior to use, the patch 102 may be stretched to the geometric boundaries of the cover 118, as shown in FIGS. 1-8. However, upon removing the cover 118 from the patch 102, the patch 102 elastically contracts thereby allowing the cover 118 to be larger in geometry then the patch 102, whereby upon re-application of the cover 118 for late use, the boundaries of the patch 102 are adequately covered, i.e., there are no exposed adhesive material 120 because the cover 118 is larger than the unstretched patch 102.

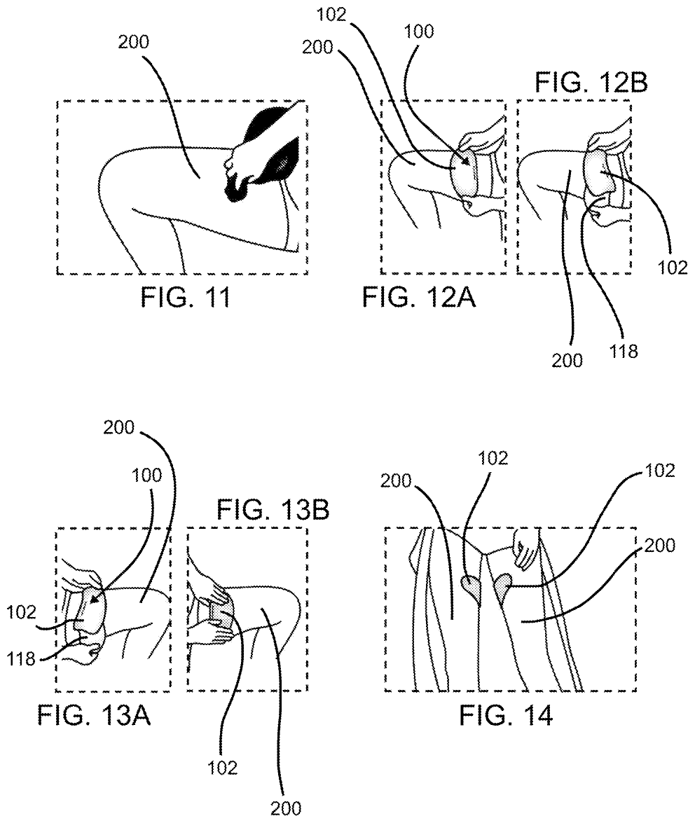

For illustrative purposes, FIGS. 11-14 illustrate the application of the thigh guard 100 on a user's body 200. FIG. 11 is a conceptual view of a step in the application of the thigh guard 100. In this step, the user cleans the inside of the thigh, taking precautions to make sure the thigh is completely dry before application. FIG. 12 is a conceptual view of a step in the application of the thigh guard 100. In this step, the user holds the patch 102 over the area that chafing occurs, making sure the linear side 110 is at the top center of the patch 102, and starting at the top left of the portion of the patch 102, slowly peel off the backing 118 while pressing against the skin. The user slides her hand down the patch 102, pressing against the skin as she peels, making sure to press firmly down from top to bottom to make sure there is no creasing. FIG. 13 is a conceptual view of a step in the application of the thigh guard 100. In this step, the user repeats the previous steps on the other leg in the same area so the patches 102 are across from each other. FIG. 14 is a conceptual view of the thigh guard installed on a user.

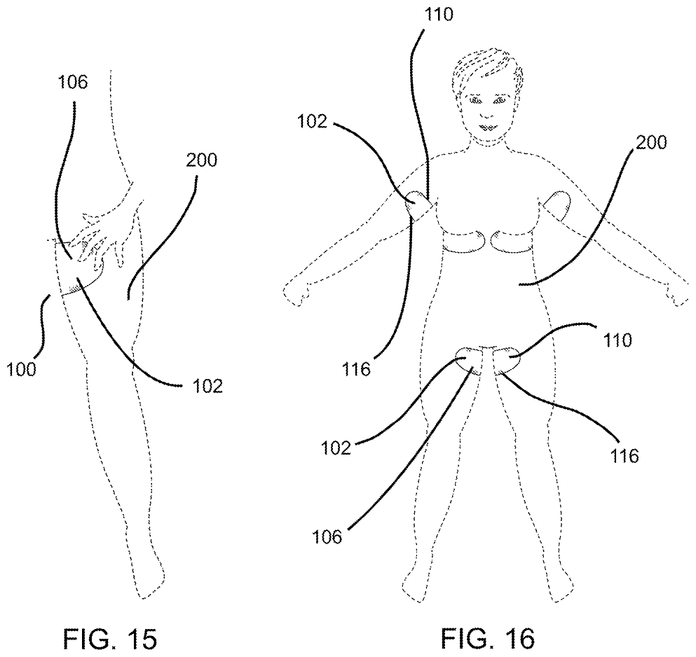

FIGS. 15 and 16 show the thigh guard 100 on a user 200. FIG. 15 is an isolated view of the thigh guard 100 on the skin of a user. FIG. 16 is a view of different areas of applications of a thigh guard 100 on a user.

While there has been shown and described above the preferred embodiment of the instant invention it is to be appreciated that the invention may be embodied otherwise than is herein specifically shown and described and that certain changes may be made in the form and arrangement of the parts without departing from the underlying ideas or principles of this invention as set forth in the Claims appended herewith.

I claim:

1. An anti-chafing thigh guard, comprising:
at least one adhesive patch;
each adhesive patch in said at least one adhesive patch is constructed of a linear sheet of material having a top surface and a bottom surface;
said linear sheet of material comprises an elastic, flexible, water-resistant, and hypoallergenic material;
said top surface defines a non-abrasive texture;
sides of said at least one adhesive patch are defined by a geometrical shape of a first linear side connecting two rounded ends which are thereby connected by a curved second side, wherein said curvature of said second side allows said at least one patch to adhere to variable polar curvature of a user's skin; and
said geometrical shape providing a surface area of each patch in said at least one adhesive patch configured to provide full coverage of an area of a user's skin subject to increased friction.

2. The anti-chafing thigh guard, as recited in claim 1, wherein said bottom surface of said at least one adhesive patch comprises a plurality of intermittent adhesive material strips affixed thereon, wherein said plurality of intermittent adhesive material strips allow sweat from a user to perspire from said user's skin on non-adhesive areas, allowing said adhesive material to affix to a user's skin without significant accumulation of sweat in locations of said plurality of intermittent adhesive material strips.

3. The anti-chafing thigh guard, as recited in claim 2, wherein said plurality of said intermittent adhesive material strips are arranged in a wave pattern in a geometrical configuration that allows for flexibility and stretchability to accommodate a plurality of curvatures of a user's skin, whereby stretching of said linear sheet of material does not affect the adhesive ability of the at least one adhesive patch.

4. The anti-chafing thigh guard, as recited in claim 1, wherein said linear sheet of material includes a smooth surface texture to prevent pulling as a result of friction against said at least one adhesive patch.

5. The anti-chafing thigh guard, as recited in claim 1, wherein said linear sheet of material provides a soft consistency to allow increased malleability when affixing to a user's skin.

6. The anti-chafing thigh guard, as recited in claim 5, wherein said linear sheet of material comprises a breathable woven texture.

7. The anti-chafing thigh guard, as recited in claim 1, wherein said linear sheet of material defines a width measurement in a range from 4-inches to 12-inches.

8. The anti-chafing thigh guard, as recited in claim 1, wherein said linear sheet of material defines a height measurement in a range from 2-inches to 6-inches.

9. The anti-chafing thigh guard, as recited in claim 1, wherein said at least one adhesive patch is a pair of identical adhesive patches.

10. The anti-chafing thigh guard, as recited in claim 1, further comprising:
a cover for protecting said adhesive material on said bottom surface of said at least one adhesive patch to prevent said adhesive patch from affixing itself to an object when not in use.

11. The anti-chafing thigh guard, as recited in claim 1, wherein said linear sheet of material is a natural fabric.

12. The anti-chafing thigh guard, as recited in claim 1, wherein said linear sheet of material is a synthetic material.

13. The anti-chafing thigh guard, as recited in claim 1, wherein said synthetic material is plastic material.

14. The anti-chafing thigh guard, as recited in claim 1, wherein the geometrical shape further defines a linear side configured to allow closer positioning to creases in a user's body, and an opposing curved end to provide fuller coverage for unencumbered areas of the user's body, whereby the geometrical shape, elasticity of the fabric, and a plurality of intermittent adhesive strips on a bottom side thereof allow the thigh guard flexibility thereby forming a moisture wicking attachment to variable polar curvature of a user's skin.

15. The anti-chafing thigh guard, as recited in claim 14, wherein the fabric is 100% cotton, and the elasticity is obtained from the material of the intermittent adhesive strips that are 100% poly-acrylic adhesive material.
